(19) United States
(12) Patent Application Publication
(10) Pub. No.: US 2013/0091455 A1
(43) Pub. Date: Apr. 11, 2013

(54) ELECTRONIC DEVICE HAVING TOUCHSCREEN AND CHARACTER INPUT METHOD THEREFOR

(71) Applicant: Samsung Electronics Co., Ltd., Gyeongi-do (KR)

(72) Inventors: Se Hwan PARK, Gyeonggi-do (KR); Ji Hoon Kim, Seoul (KR); Sung Wook Park, Gyeonggi-do (KR); Ji Hoon Lee, Gyeonggi-do (KR)

(73) Assignee: Samsung Electronics Co., Ltd., Gyeonggi-do (KR)

(21) Appl. No.: 13/646,000

(22) Filed: Oct. 5, 2012

(30) Foreign Application Priority Data
Oct. 6, 2011 (KR) 10-2011-0101908

(51) Int. Cl. G06F 3/048

(52) U.S. Cl. 715/773

(57) ABSTRACT

An electronic device having a touchscreen and a character input method which enable the user to enter characters more conveniently through a virtual keyboard area having a minimum number of character input regions by displaying a virtual keyboard area, displaying basic characters entered through the virtual keyboard area, displaying one or more candidate words corresponding to the entered basic characters, and displaying, when one of the candidate words is selected, the selected candidate word, using a virtual keyboard area having a minimum number of consonant and vowel key regions so that the user can enter characters without much awareness of consonant and vowel key positions.

### PRIORITY

This application claims priority under 35 U.S.C. §119(a) to Korean Patent Application Serial No. 10-2011-0101908, which was filed in the Korean Intellectual Property Office on Oct. 6, 2011, the entire disclosure of which is incorporated herein by reference.

### BACKGROUND OF THE INVENTION

1. Field of the Invention

The present invention relates generally to a character input method for an electronic device having a touchscreen and, more particularly, to an electronic device having a touchscreen and a character input method for the same that enable the user to enter characters more conveniently through a virtual keyboard area having a minimum number of character input regions.

2. Description of the Related Art

In recent years, touchscreens have been increasingly utilized in portable electronic devices such as mobile phones and Personal Digital Assistants (PDA) to increase display areas of the electronic devices while reducing the weight and thickness thereof.

Generally, character input through a touchscreen is performed using a virtual keyboard area displayed on the touchscreen. In particular, for a language utilizing multi-stroke characters such as Hangul (Korean alphabet), the virtual keyboard area may be composed of consonant key regions corresponding to individual consonants and vowel key regions corresponding to individual vowels. For example, in a qwerty layout for Hangul, there may be 13 consonant key regions for entering consonants ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’ and ‘ [symbol] ’, and 12 vowel key regions for entering vowels ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’ and ‘ [symbol] ’.

A portable electronic device such as a mobile phone displaying a virtual keyboard area has a size limitation for high portability or mobility. As the virtual keyboard area having many key regions corresponding to consonants and vowels is much smaller than a hardware keyboard of a desktop computer, it may be difficult for the user to enter characters without viewing the entire virtual keyboard area.

### SUMMARY OF THE INVENTION

Accordingly, the present invention has been made in to solve the above mentioned problems and the present invention provides an electronic device having a touchscreen and a character input method for the same that enable the user to enter characters through a virtual keyboard area more conveniently.

According to an aspect of the present invention, there is provided an electronic device having a touchscreen and a character input method for the same that employ a virtual keyboard area having a minimum number of consonant and vowel key regions so that the user can enter characters without much awareness of consonant and vowel key positions.

According to an aspect of the present invention, there is provided a character input method using a touchscreen by displaying a virtual keyboard area, displaying basic characters entered through the virtual keyboard area, displaying one or more candidate words corresponding to the entered basic characters, and displaying, when one of the candidate words is selected, the selected candidate word.

According to an aspect of the present invention, there is provided an electronic device including a touchscreen displaying a character input screen that is composed of a virtual keyboard area to enter basic characters, an input character display area to display basic characters entered through the virtual keyboard area, and a candidate group display area to display one or more candidate words corresponding to the entered basic characters, and a control unit controlling a process of displaying a basic character associated with one of touched basic consonant and vowel regions in the virtual keyboard area, generating and displaying candidate words on the basis of the displayed basic character, and displaying a selected one of the candidate words in the input character display area.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram of an electronic device having a touchscreen according to an embodiment of the present invention;

FIGS. 2 to 9 are diagrams illustrating screen representations for a first character input method using a touchscreen according to an embodiment of the present invention;

FIGS. 10 to 13 are diagrams illustrating handling of edit events through the virtual keyboard area according to an embodiment of the present invention;

FIG. 14 is a flowchart illustrating the first character input method using a touchscreen according to an embodiment of the present invention;

FIG. 15 is a flowchart illustrating a procedure for displaying basic characters in the first method of FIG. 14, according to an embodiment of the present invention;

FIG. 16 is a diagram illustrating a screen representation for a second character input method using a touchscreen according to an embodiment of the present invention;

FIG. 17 is a diagram illustrating a screen representation for a third character input method using a touchscreen according to an embodiment of the present invention;

FIGS. 18 to 22 are diagrams illustrating screen representations for a fourth character input method using a touchscreen according to an embodiment of the present invention;

FIG. 23 is a flowchart illustrating the fourth character input method using a touchscreen according to an embodiment of the present invention; and

FIG. 24 is a flowchart illustrating a procedure for displaying a character in the fourth method of FIG. 23, according to an embodiment of the present invention.

### DETAILED DESCRIPTION OF EMBODIMENTS OF THE PRESENT INVENTION

Hereinafter, various embodiments of the present invention are described in detail with reference to the accompanying drawings. In the following description, an electronic device having a touchscreen and a character input method therefore, according to an embodiment of the present invention is described in detail.

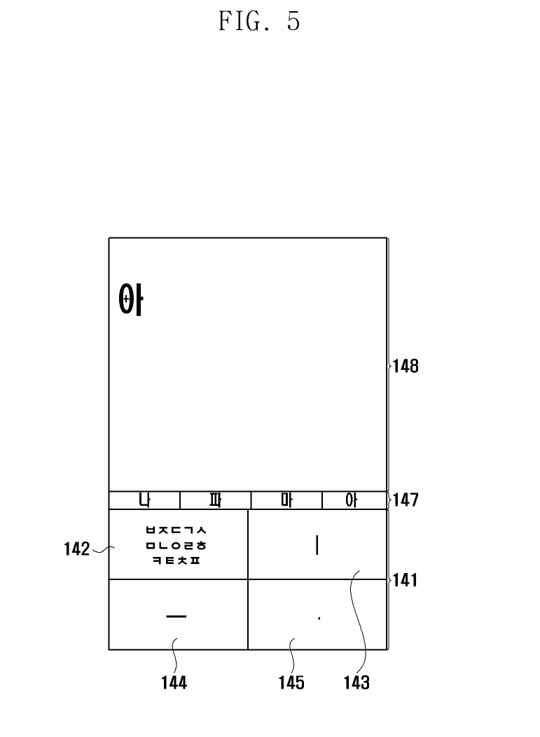

In the description, “basic consonants” indicate consonants that may represent all consonants. In the drawings, a basic consonant is presented as a symbol ‘+’ inside the consonant ‘ [symbol] ’ (as indicated by an input character display area 148 of FIG. 5), and may be represented by other symbols. In the description, a basic consonant is represented as ‘x’ for ease of description. A “basic character” may indicate a character made up of a basic consonant, a vowel, or a basic consonant plus a vowel.

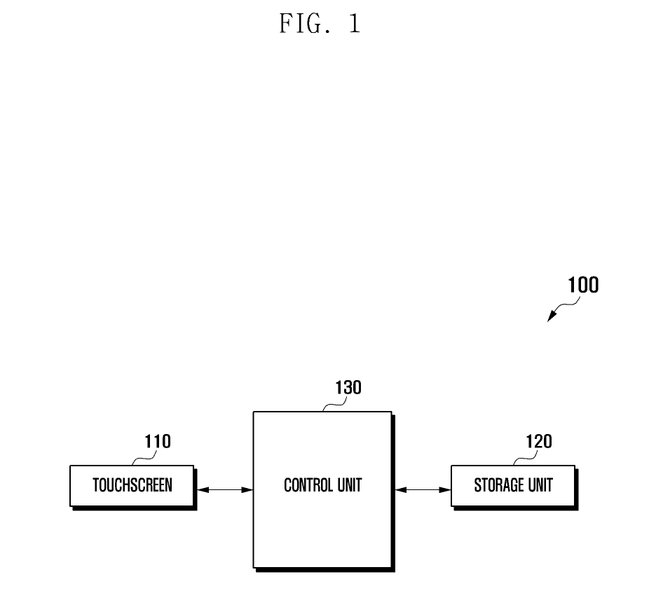

FIG. 1 is a block diagram of an electronic device 100 having a touchscreen according to an embodiment of the present invention.

Referring to FIG. 1, the electronic device 100 includes a touchscreen 110, a storage unit 120, and a control unit 130.

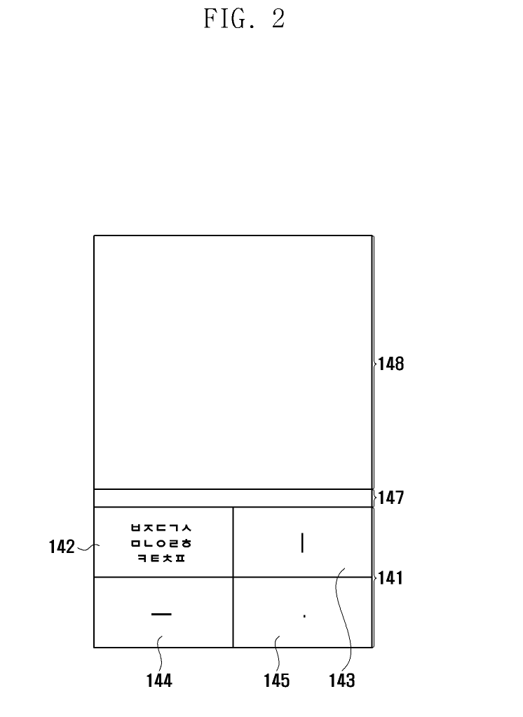

The touchscreen 110 displays operation states of the electronic device 100 under control of the control unit 130, and generates touch data corresponding to a user touch and sends the touch data to the control unit 130. When the control unit 130 operates in a character input mode, the touchscreen 110 displays a character input screen as illustrated in FIG. 2. The character input screen includes a virtual keyboard area 141 for entering basic characters, an input character display area 148 for displaying basic characters entered through the virtual keyboard area 141, and a candidate group display area 147 for displaying a group of candidate words corresponding to basic characters. The virtual keyboard area 141 includes a basic consonant region 142 for entering basic consonants, a first vowel region 143 for entering ‘ [symbol] ’ vowels, a second vowel region 144 for entering ‘ [symbol] ’ vowels, and a third vowel region 145 for entering ‘ [symbol] ’ vowels. Although three vowel regions 143, 144 and 145 are illustrated, the number of vowel regions may vary. The first to third vowel regions 143, 144 and 145 may be used to enter vowels other than ‘ [symbol] ’ vowels, ‘ [symbol] ’ vowels and ‘ [symbol] ’ vowels.

The storage unit 120 stores data used to control the electronic device 100. The storage unit 120 stores a database containing registered words, usage frequencies of the words, and key input sequences for the words as shown in Table 1. The words in the database may correspond to basic characters entered through the virtual keyboard area 141.

TABLE 1

| | | Usage | |
|---|---|---|---|
| Field | Word | frequency | Key input sequence |
| 1 | [symbol] | 1230 | x [symbol] x x [symbol] x x [symbol] x [symbol] x [symbol] |
| | (hello) | | |
| 2 | [symbol] | 110 | x [symbol] x x [symbol] x x [symbol] x [symbol] x [symbol] |
| | (give up) | | |
| 3 | [symbol] | 8 | x [symbol] x x [symbol] x x [symbol] x [symbol] x [symbol] |
| ` | (sleep well) | | |
| 4 | [symbol] | 800 | x [symbol] x x [symbol] x [symbol] x xl x [symbol] |
| | (thanks) | | |
| 5 | [symbol] | 200 | x [symbol] x [symbol] x x [symbol] |
| | (love you) | | |
| . . . | . . . | . . . | . . . |

The control unit 130 controls the overall operation of the electronic device 100. During display of the character input screen, the control unit 130 controls the touchscreen 110 to display basic characters entered through the virtual keyboard area 141 in the input character display area 148. Here, the control unit 130 controls an operation to display a basic consonant or a vowel, which corresponds to a touch on the virtual keyboard area 141, in the input character display area 148. The control unit 130 checks whether a word corresponding to the displayed basic characters in the input character display area 148 is present in the database of the storage unit 120. Here, basic characters are determined by the key input sequence for basic consonants or vowels, and the word for database search includes characters corresponding to syllables of the basic characters. A syllable may include an initial consonant, an initial consonant plus a vowel, or an initial consonant plus a vowel plus a final consonant. A database search is performed by examining the type of the vowel of each syllable of the basic characters and checking presence of a basic consonant (final consonant) in the syllable. For example, when a basic character ‘xI’ is displayed in the input character display area 148, words starting with a syllable of one of consonants (‘ [symbol] ’, ‘ [symbol] ’, ‘ [symbol] ’, . . . ) corresponding to the basic consonant ‘x’ plus the vowel ‘I’ are found from the database.

When words corresponding to the entered basic characters are present in the database, the control unit 130 controls the touchscreen 110 to display candidate words corresponding to the basic characters in the candidate group display area 147. When one of the candidate words is selected, the control unit 130 controls the touchscreen 110 to display the selected candidate word. In response to a display request for additional candidate words, the control unit 130 may control the touchscreen 110 to display additional candidate words, which have not yet been displayed in the candidate group display area 147, in the candidate group display area 147. The control unit 130 may also control the touchscreen 110 to perform an edit operation entered through the virtual keyboard area 141.

FIGS. 2 to 9 are diagrams illustrating screen representations of a first character input method using a touchscreen according to an embodiment of the present invention. In FIGS. 2 to 9, it is assumed that the user wishes to enter a word “ [symbol] ” (hello).

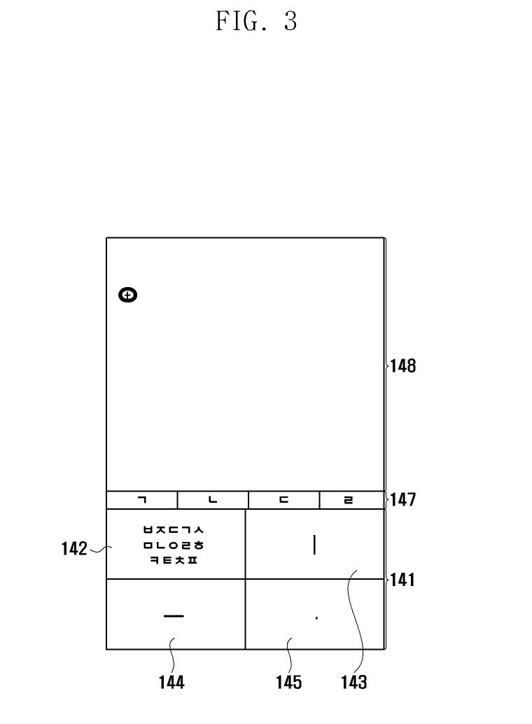

When the user makes a request for the character input mode, a character input screen is displayed as illustrated in FIG. 3. Here, the user may touch a character input icon on the touchscreen 110. As described before, the character input screen is composed of a virtual keyboard area 141 including a basic consonant region 142 and first to third vowel regions 143 to 145, a candidate group display area 147, and an input character display area 148.

The user touches the basic consonant region 142 to enter the initial consonant ‘ [symbol] ’ for the first syllable ‘ [symbol] ’. Then, the control unit 130 controls the touchscreen 110 to display a basic consonant in the input character display area 148 as illustrated in FIG. 3. The control unit 130 searches the database for consonants represented by a basic consonant ‘x’, and controls the touchscreen 110 to display found consonants (for example, ‘ [symbol] ’, ‘ [symbol] ’, ‘ [symbol] ’, ‘ [symbol] ’, . . . ) in the candidate group display area 147 as illustrated in FIG. 3.

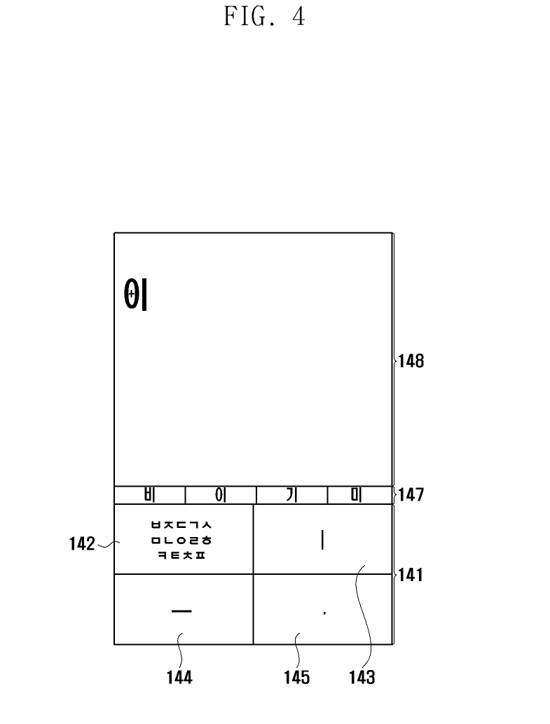

The user touches the first vowel region 143 to enter the vowel ‘ [symbol] ’ of ‘ [symbol] ’ Then, the control unit 130 controls the touchscreen 110 to display the vowel ‘I’ next to the basic consonant in the input character display area 148 as illustrated in FIG. 4. The control unit 130 searches the database for words represented by a basic character ‘xI’ (basic consonant ‘x’ plus vowel T), and controls the touchscreen 110 to display found words (for example, ‘ [symbol] ’, ‘ [symbol] ’, ‘ [symbol] ’, ‘ [symbol] ’, . . . ) in the candidate group display area 147 as illustrated in FIG. 4.

The user touches the third vowel region 145 to enter the vowel ‘ [symbol] ’ of ‘ [symbol] ’. Then, the control unit 130 changes the vowel ‘I’ to the vowel ‘ [symbol] ’ in the input character display area 148 as illustrated in FIG. 5. The control unit 130 searches the database for words represented by a basic character ‘x [symbol] ’ (basic consonant ‘x’ plus vowel ‘ [symbol] ’), and controls the touchscreen 110 to display found words (for example, ‘ [symbol] ’, ‘ [symbol] ’, ‘ [symbol] ’, ‘ [symbol] ’, . . . ) in the candidate group display area 147 as illustrated in FIG. 5.

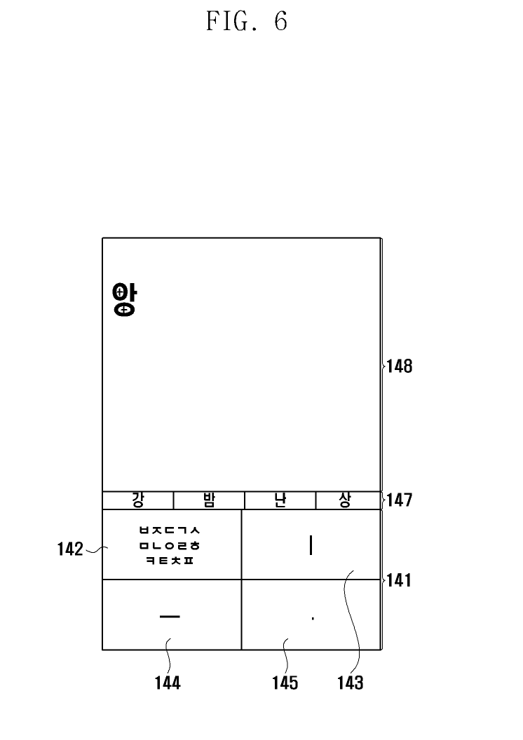

The user touches the basic consonant region 142 to enter the final consonant ‘ [symbol] ’ for ‘ [symbol] ’. Then, the control unit 130 controls the touchscreen 110 to display the basic consonant ‘x’ under the basic character ‘x [symbol] ’ in the input character display area 148 as illustrated in FIG. 6. The control unit 130 searches the database for words represented by a basic character ‘ [symbol] ’ (basic consonant ‘x’ as initial consonant plus vowel ‘ [symbol] ’ plus basic consonant ‘x’ as final consonant), and controls the touchscreen 110 to display found words (for example, ‘ [symbol] ’, ‘ [symbol] ’, ‘ [symbol] ’, ‘ [symbol] ’, . . . ) in the candidate group display area 147 as illustrated in FIG. 6.

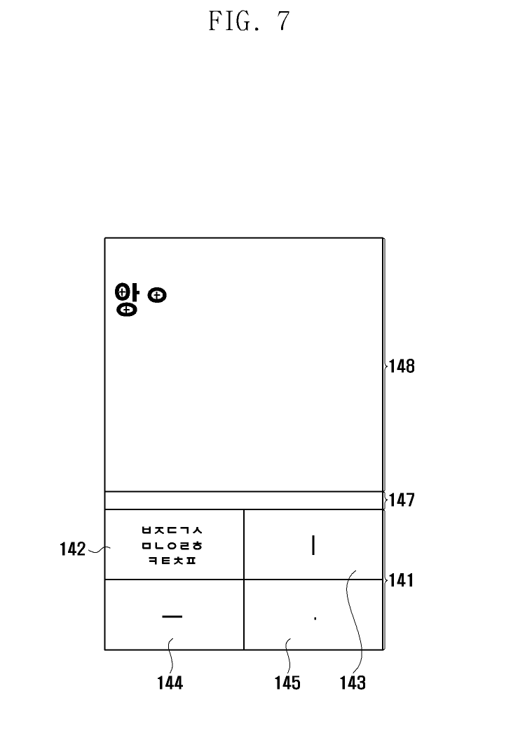

The user touches the basic consonant region 142 to enter the initial consonant ‘ [symbol] ’ for the second syllable ‘ [symbol] ’. Then, the control unit 130 controls the touchscreen 110 to display a basic consonant on the right of the first syllable in the input character display area 148 as illustrated in FIG. 7. The control unit 130 searches the database for words represented by a basic character ‘ [symbol] ’, and controls the touchscreen 110 to display found words in the candidate group display area 147. In FIG. 7, as no word corresponding to the basic character ‘ [symbol] ’ is found in the database, no word is displayed in the candidate group display area 147.

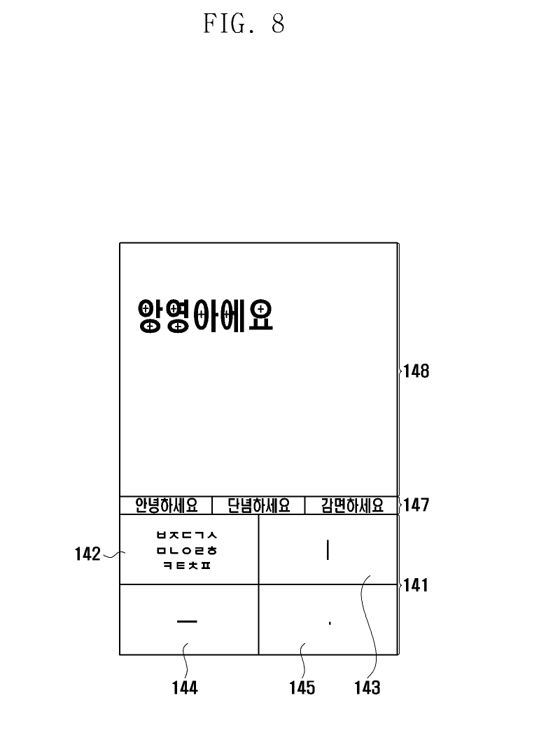

When the user enters basic characters “ [symbol] ” by repeating the procedure above, the basic characters are displayed in the input character display area 148 as illustrated in FIG. 8. The control unit 130 searches the database for words corresponding to the basic characters “ [symbol] ”, and controls the touchscreen 110 to display found words (for example, “ [symbol] ”, “ [symbol] ”, “ [symbol] ”, . . . ) in the candidate group display area 147.

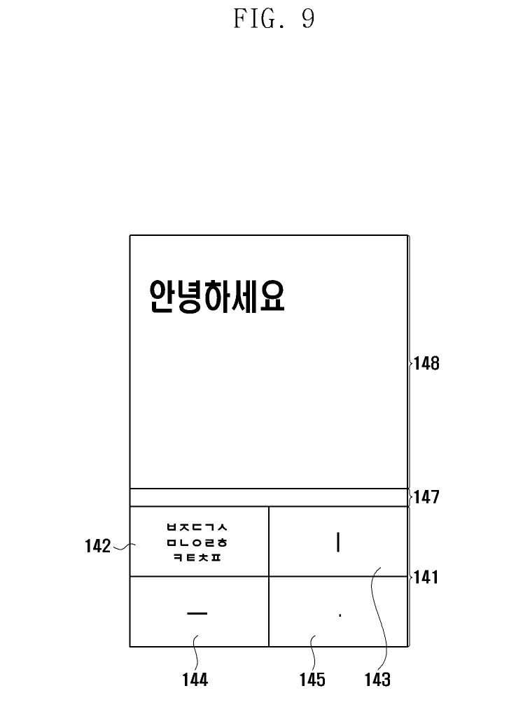

The user selects the word “ [symbol] ” by touching a region at which the word “ [symbol] ” is displayed in the candidate group display area 147. Then, the control unit 130 controls the touchscreen 110 to display the selected word “ [symbol] ” in the input character display area 148 as illustrated in FIG. 9.

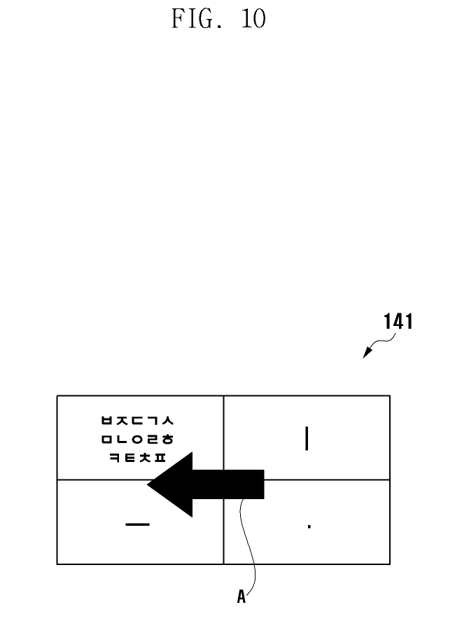

FIGS. 10 to 13 illustrate handling of edit events through the virtual keyboard area 141.

FIG. 10 illustrates entering a backspace. The user may enter a backspace by dragging in the left direction (as indicated by arrow A) on the virtual keyboard area 141. In response to the backspace, a basic character may be deleted while moving the cursor in the left direction on the input character display area 148.

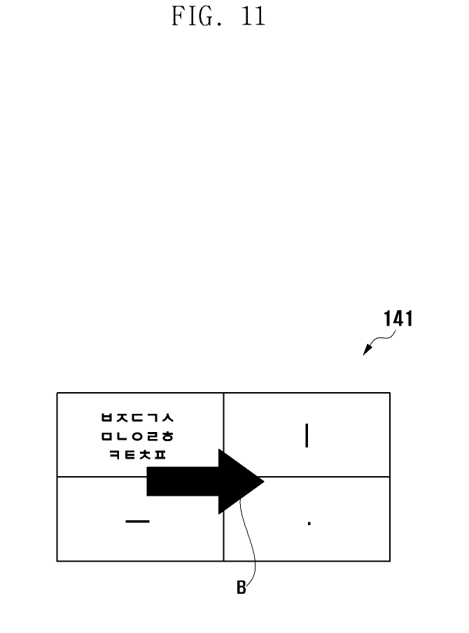

FIG. 11 illustrates entering a space. The user may enter a space by dragging in the right direction (as indicated by arrow B) on the virtual keyboard area 141. In response to the space, the cursor may be moved in the right direction.

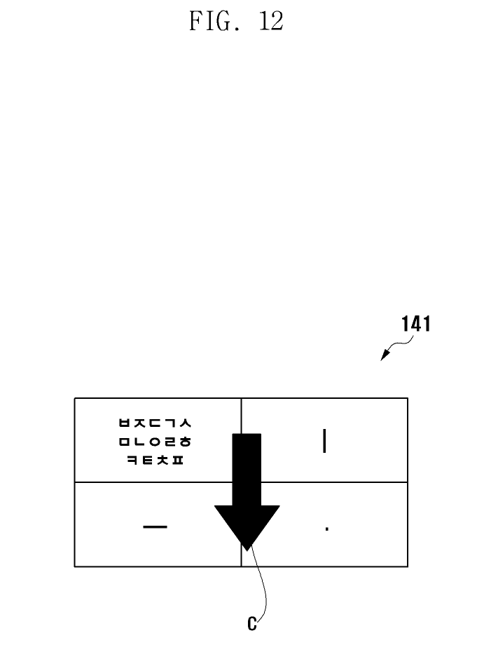

FIG. 12 illustrates an enter input. The user may input an enter by dragging downwards (as indicated by arrow C) on the virtual keyboard area 141. In response to the enter, the cursor may be moved to the next line.

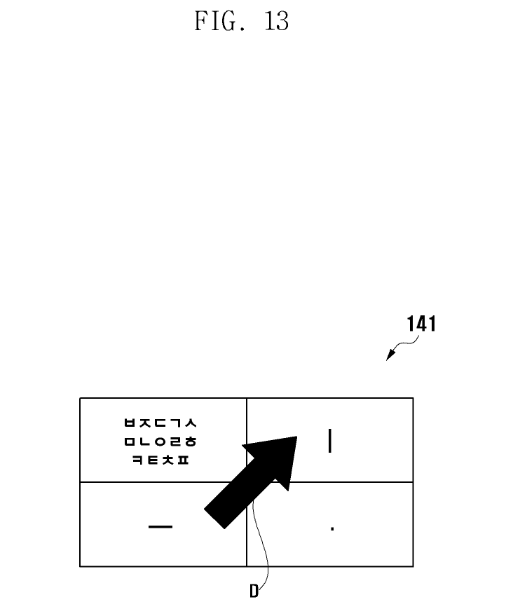

FIG. 13 illustrates a change in the input mode. The user may change the input mode by dragging sideways (as indicated by arrow D) on the virtual keyboard area 141. An input mode change may cause a transition between English and Korean modes or between numeric and symbolic modes.

When no candidate word among candidate words displayed in the candidate group display area 147 is selected, inputting a space, an enter or an input mode change may cause automatic selection of a candidate word with the highest usage frequency (hereinafter, referred to as “automatic selection”).

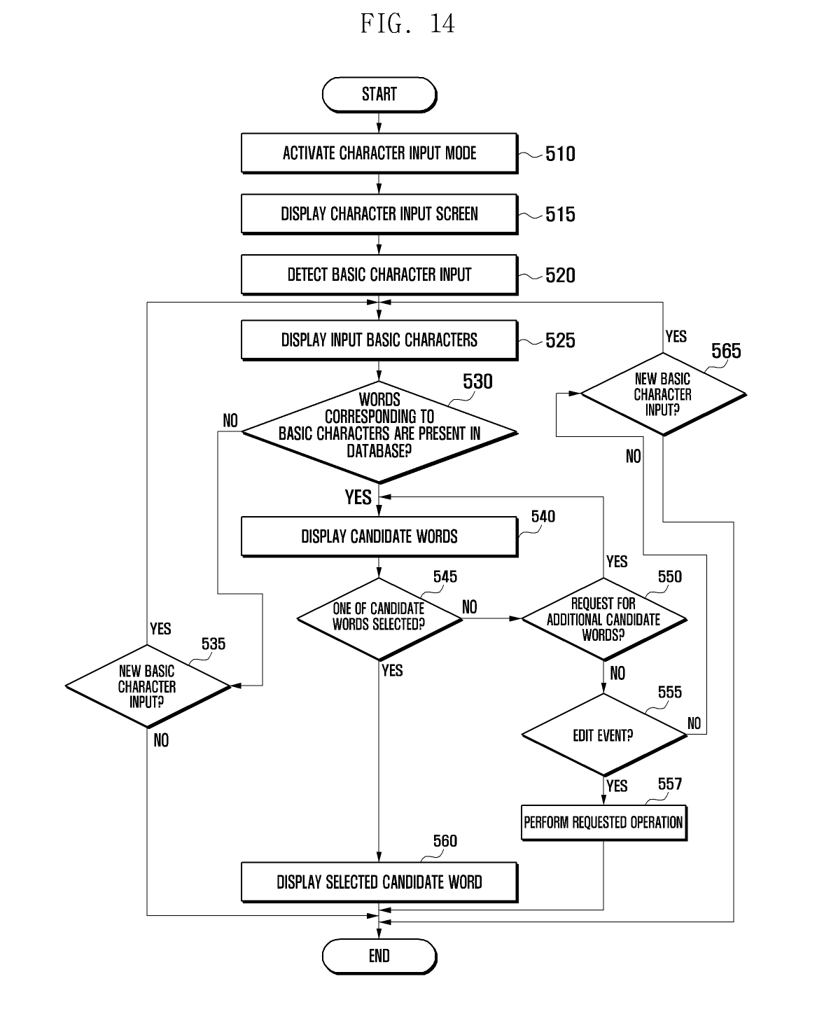

FIG. 14 is a flowchart of the first character input method using a touchscreen.

Referring to FIG. 14, when a request signal for the character input mode is received from the touchscreen 110, the control unit 130 transitions to the character input mode in Step 510. Here, when the user touches a character input icon on the touchscreen 110, the touchscreen 110 may generate a request signal for the character input mode and send the same to the control unit 130.

In the character input mode, the control unit 130 controls the touchscreen 110 to display a character input screen as illustrated in FIG. 2 in Step 515. The control unit 130 detects input of basic characters through the virtual keyboard area 141 of the character input screen in Step 520. Upon detection of basic character input, the control unit 130 controls the touchscreen 110 to display basic characters entered through the virtual keyboard area 141 in the input character display area 148 in Step 525.

The control unit 130 checks whether words corresponding to the displayed basic characters in the input character display area 148 are present in the database in Step 530. Here, a database search is performed to find words that include characters corresponding to syllables of the basic characters. Database search may include a process of examining the type of the vowel of each syllable of the basic characters and checking presence of a final consonant in the syllable.

When no words corresponding to the basic characters are present in the database, the control unit 130 checks whether a new basic character is input through the virtual keyboard area 141 in Step 535. When no new basic character is input, the control unit 130 ends the process. When a new basic character is input, the control unit 130 returns to Step 525 and displays the new basic character in the input character display area 148.

When words corresponding to the basic characters are present in the database, the control unit 130 controls the touchscreen 110 to display some or all of the words corresponding to the basic characters (candidate words) in the candidate group display area 147 in Step 540. For example, in FIG. 5, words ‘ [symbol] ’, ‘ [symbol] ’, ‘ [symbol] ’ and ‘ [symbol] ’ corresponding to one basic consonant are displayed in the candidate group display area 147; and, in FIG. 6, words ‘ [symbol] ’, ‘ [symbol] ’, ‘ [symbol] ’ and ‘ [symbol] ’ corresponding to a basic character (syllable made up of a basic consonant plus the vowel ‘ [symbol] ’) are displayed in the candidate group display area 147. The candidate words may be arranged from the left to the right in the candidate group display area 147 in descending order of usage frequencies recorded in the database.

The control unit 130 determines whether one of the candidate words displayed in the candidate group display area 147 is selected in Step 545. Selection of a candidate word may be made by touching a region at which the candidate word is displayed. When a candidate word is selected, the control unit 130 controls the touchscreen 110 to display the selected candidate word in the input character display area 148 in Step 560. For example, after displaying candidate words “ [symbol] ”, “ [symbol] ” and “ [symbol] ” in the candidate group display area 147 as illustrated in FIG. 10, when the word “ [symbol] ” is selected, the selected word “ [symbol] ” is displayed in the input character display area 148 as illustrated in FIG. 11.

When no candidate word is selected, the control unit 130 checks whether a display request for additional candidate words not yet displayed in the candidate group display area 147 is made in Step 550. A display request for additional candidate words may be made by dragging in the left direction on the candidate group display area 147. When a display request for additional candidate words is made, the control unit 130 returns to Step 540 and displays next candidate words in the candidate group display area 147.

When a display request for additional candidate words is not made, the control unit 130 checks whether an edit event is generated in Step 555. Here, an edit event may correspond to generation of a backspace, a space, an enter or an input mode change. When an edit event is generated, the control unit 130 performs an operation indicated by the edit event in Step 557.

When an edit event is not generated, the control unit 130 checks whether a new basic character is input through the virtual keyboard area 141 in Step 565. When a new basic character is input, the control unit 130 returns to Step 525 and displays the new basic character in the input character display area 148. When no new basic character is input, the control unit 130 ends the process.

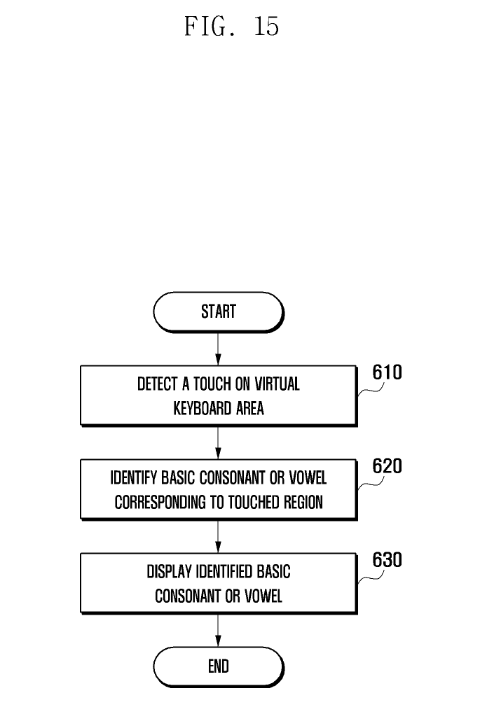

FIG. 15 is a flowchart of a procedure for displaying basic characters according to the method of FIG. 14.

Referring to FIG. 15, the control unit 130 detects a touch on the virtual keyboard area 141 in Step 610. The control unit 130 identifies a basic consonant or a vowel corresponding to the touched region in Step 620. For example, when the basic consonant region 142 is touched on the virtual keyboard area 141, the control unit 130 regards a basic consonant as a basic character.

The control unit 130 displays the identified basic consonant or vowel in the input character display area 148 in Step 630. For example, when the basic consonant region 142 is touched, a basic consonant corresponding to the basic consonant region 142 is displayed in the input character display area 148 as illustrated in FIG. 5.

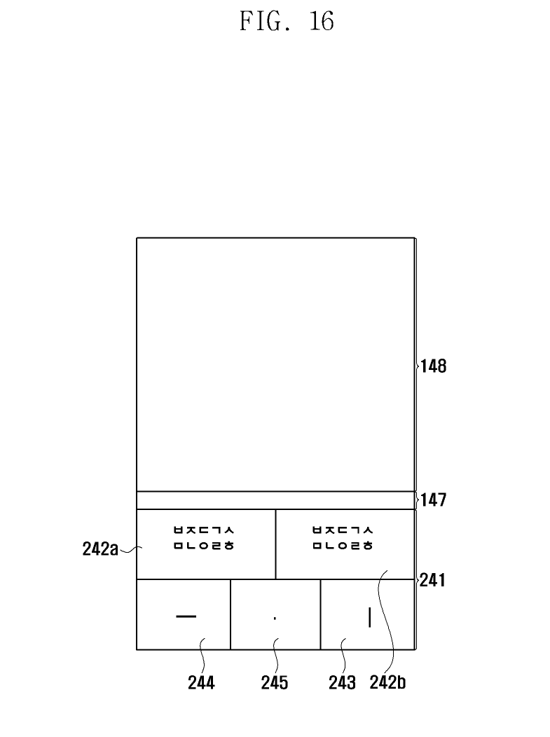

FIG. 16 illustrates a character input screen for a second character input method using a touchscreen according to an embodiment of the present invention.

Referring to FIG. 16, unlike the virtual keyboard area 141 of the first method, the virtual keyboard area 241 of the second method includes a first basic consonant region 242a, a second basic consonant region 242b, a first vowel region 243, a second vowel region 244 and a third vowel region 245. Here, the first basic consonant region 242a is used to enter a basic consonant corresponding to an initial consonant, and the second basic consonant region 242b is used to enter a basic consonant corresponding to a final consonant. The first vowel region 243, the second vowel region 244 and the third vowel region 245 are used for entering ‘ [symbol] ’ vowels, ‘ [symbol] ’ vowels and ‘ [symbol] ’ vowels, respectively. For example, assume that the user wishes to enter a word “ [symbol] ”. In the first method, after a basic character corresponding to ‘ [symbol] ’ is displayed as illustrated in FIG. 5, when the user touches the basic consonant region 142 to enter ‘ [symbol] ’ for ‘ [symbol] ’, a basic character is displayed as illustrated in FIG. 6. In the second method, after a basic character corresponding to ‘ [symbol] ’ is displayed, when the user touches the first basic consonant region 142a to enter the first consonant ‘ [symbol] ’ for ‘ [symbol] ’, a basic consonant corresponding to ‘ [symbol] ’ is displayed on the right of the basic character displayed in the input character display area 148 of FIG. 5. As described above, as the virtual keyboard area 241 of the second method separately includes the first basic consonant region 242a for initial consonants and the second basic consonant region 242b for final consonants, the character input process becomes more natural to the eye of the user in comparison to the first method.

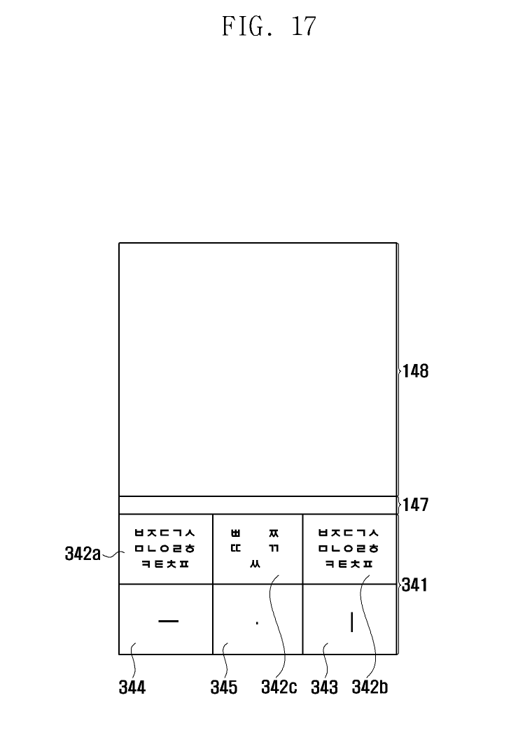

FIG. 17 illustrates a character input screen for a third character input method using a touchscreen according to an embodiment of the present invention.

Referring to FIG. 17, similarly to the virtual keyboard area 241 of the second method, the virtual keyboard area 341 of the third method includes a first vowel region 343, a second vowel region 344 and a third vowel region 345. Here, the first vowel region 343, the second vowel region 344 and the third vowel region 345 are used for entering ‘ [symbol] ’ vowels, ‘ [symbol] ’ vowels and ‘ [symbol] ’ vowels, respectively. Unlike the virtual keyboard area 241 of the second method, the virtual keyboard area 341 of the third method includes a first basic consonant region 342a, a second basic consonant region 342b, and a third basic consonant region 342c. Here, the first basic consonant region 342a, the second basic consonant region 342b, and the third basic consonant region 342c are used to enter a basic consonant corresponding to an initial single consonant, a basic consonant corresponding to a final single consonant, and a basic consonant corresponding to a double consonant, respectively. In comparison to the second method, as the virtual keyboard area 341 of the third method separately includes the first basic consonant region 342a and the second basic consonant region 342b for single consonants, and the third basic consonant region 342c for double consonants, the number of candidate words can be reduced. Hence, the user may select a word to be entered in a more rapid manner.

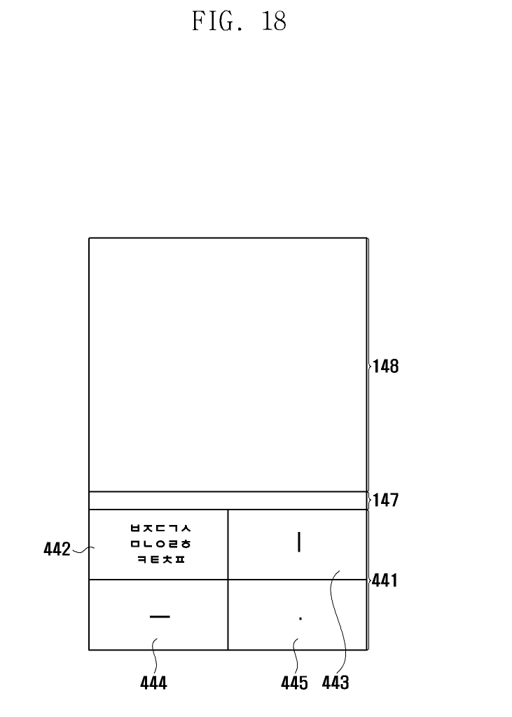

FIGS. 18 to 22 are diagrams illustrating screen representations of a fourth character input method using a touchscreen according to an embodiment of the present invention. In FIGS. 18 to 22, it is assumed that the user wishes to enter a word “ [symbol] ” (memory).

When the user makes a request for the character input mode, a character input screen is displayed as illustrated in FIG. 18. The character input screen of the fourth method includes a virtual keyboard area 441, a candidate group display area 147 and an input character display area 148.

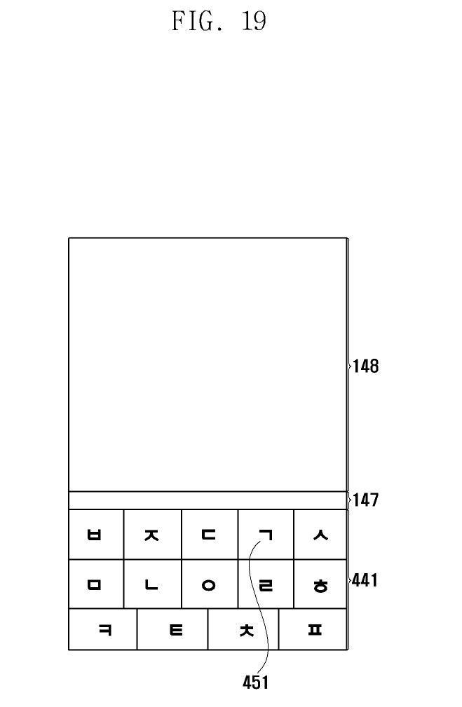

The virtual keyboard area 441 includes a unified consonant region 442, a first vowel region 443, a second vowel region 444 and a third vowel region 445. Here, when the user touches the unified consonant region 442, individual consonant key regions are displayed as illustrated in FIG. 19. A touch event for displaying consonant key regions may be a long touch lasting for a preset time on the unified consonant region 442 or a short touch like a tap on the unified consonant region 442. The first vowel region 443, the second vowel region 444 and the third vowel region 445 are used for entering ‘ [symbol] ’ vowels, ‘ [symbol] ’ vowels and ‘ [symbol] ’ vowels, respectively.

The user touches the unified consonant region 442 to enter the initial consonant ‘ [symbol] ’ for ‘ [symbol] ’. Then, the control unit 130 displays individual consonant key regions in the virtual keyboard area 441 as illustrated in FIG. 19.

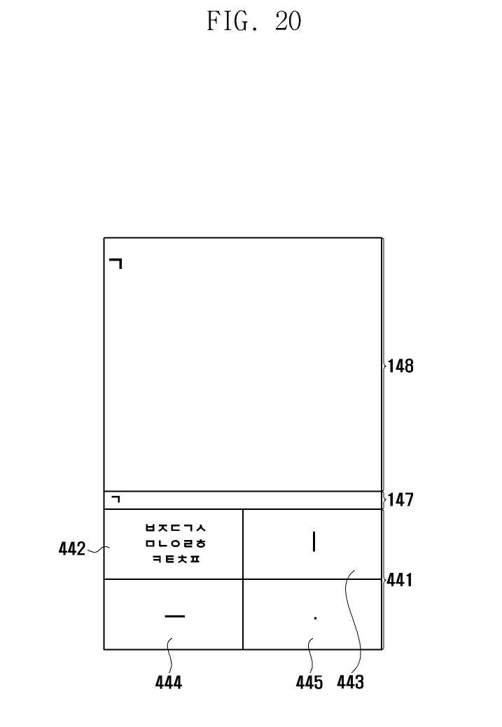

The user touches a consonant key region 451 corresponding to ‘ [symbol] ’. Then, the control unit 130 controls the touchscreen 110 to display the consonant ‘ [symbol] ’ in the input character display area 148 as illustrated in FIG. 20. The control unit 130 searches the database for a word containing the character (‘ [symbol] ’) displayed in the input character display area 148, and controls the touchscreen 110 to display found words in the candidate group display area 147 as illustrated in FIG. 20. Here, the control unit 130 searches the database for words containing characters corresponding to syllables including input consonant and vowel sequences. In FIG. 20, because only a word ‘ [symbol] ’ is present in the database as a character or syllable including the initial consonant ‘ [symbol] ’ the consonant ‘ [symbol] ’ is displayed in the candidate group display area 147.

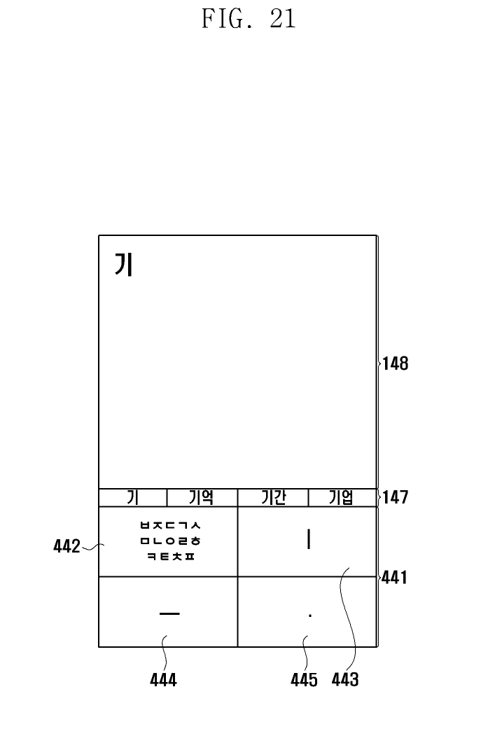

The user touches the first vowel region 443 to enter the vowel ‘I’ for ‘ [symbol] ’. Then, the control unit 130 displays the vowel ‘I’ on the right of ‘ [symbol] ’ in the input character display area 148 as illustrated in FIG. 21. The control unit 130 searches the database for words containing the character ‘ [symbol] ’ displayed in the input character display area 148, and controls the touchscreen 110 to display found words (for example, “ [symbol] ”, “ [symbol] ”, “ [symbol] ”, “ [symbol] ”, . . . ) in the candidate group display area 147 as illustrated in FIG. 21.

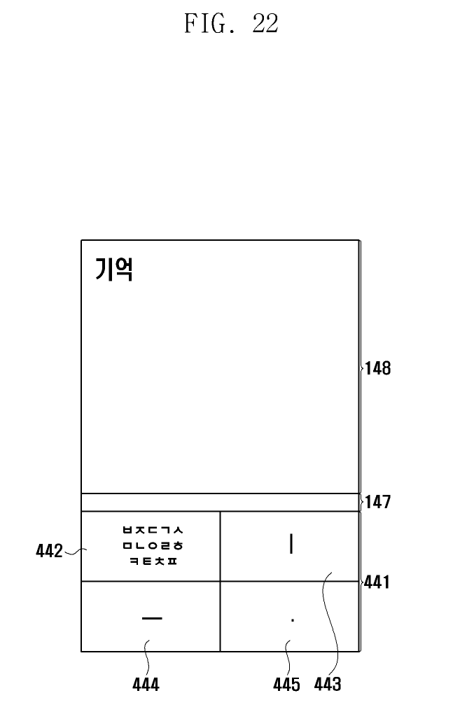

The user selects the word “ [symbol] ” among the candidate words displayed in the candidate group display area 147. Then, the control unit 130 displays the selected word “ [symbol] ” in the input character display area 148 as illustrated in FIG. 22.

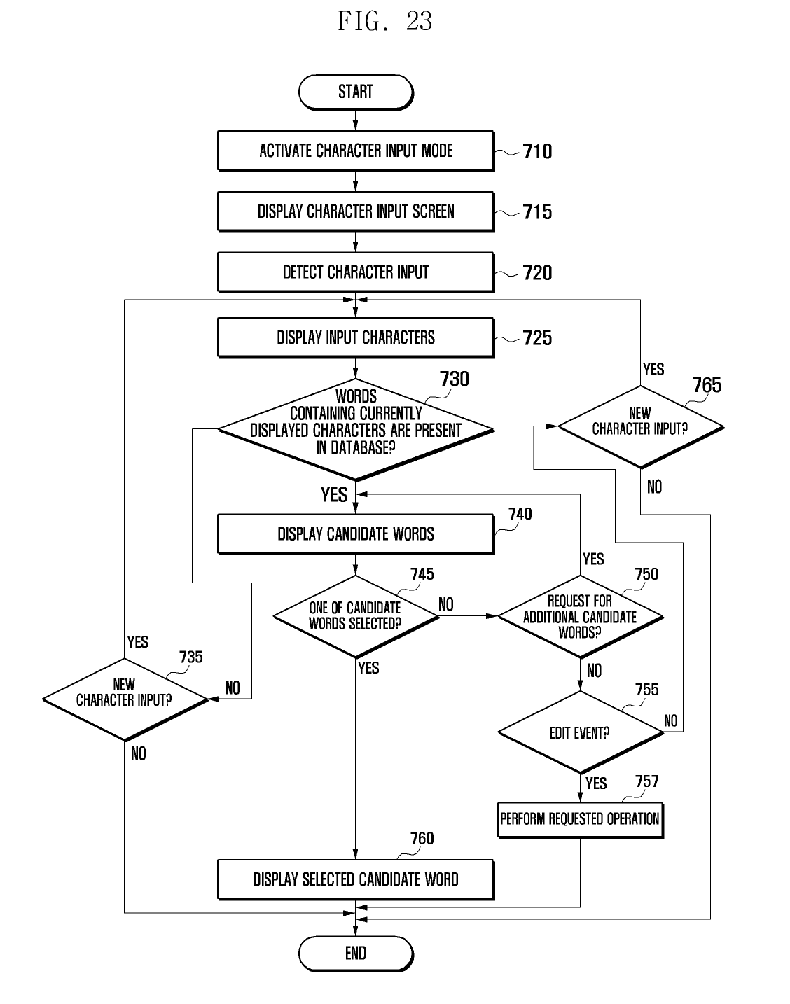

FIG. 23 is a flowchart of the fourth character input method using a touchscreen.

Referring to FIG. 23, when a request signal for the character input mode is received from the touchscreen 110, the control unit 130 transitions to the character input mode in Step 710. Here, when the user touches a character input icon on the touchscreen 110, the touchscreen 110 may generate a request signal for the character input mode and send the same to the control unit 130.

In the character input mode, the control unit 130 controls the touchscreen 110 to display a character input screen as illustrated in FIG. 18 in Step 715. The control unit 130 detects input of a character through the virtual keyboard area 441 of the character input screen in Step 720. Upon detection of character input, the control unit 130 controls the touchscreen 110 to display the character entered through the virtual keyboard area 441 in the input character display area 148 in Step 725.

The control unit 130 checks whether words containing characters currently displayed in the input character display area 148 are present in the database in Step 725. When no words containing currently displayed characters are present in the database, the control unit 130 checks whether a new character is input through the virtual keyboard area 441 in Step 735. When no new character is input, the control unit 130 ends the process. When a new character is input, the control unit 130 returns to Step 725 and displays the new character in the input character display area 148.

When words containing currently displayed characters are present in the database, the control unit 130 controls the touchscreen 110 to display some or all of the words containing currently displayed characters (candidate words) in the candidate group display area 147 in Step 740. For example, when a character ‘ [symbol] ’ is displayed in the input character display area 148 as illustrated in FIG. 21, candidate words containing ‘ [symbol] ’, such as “ [symbol] ”, “ [symbol] ”, “ [symbol] ” and “ [symbol] ”, may be displayed in the candidate group display area 147.

The control unit 130 determines whether one of the candidate words displayed in the candidate group display area 147 is selected in Step 745. When a candidate word is selected, the control unit 130 displays the selected candidate word in the input character display area 148 in Step 760. For example, when a word “ [symbol] ” is selected among the candidate words “ [symbol] ”, “ [symbol] ”, “ [symbol] ” and “ [symbol] ” displayed in the candidate group display area 147, the selected word “ [symbol] ” is displayed in the input character display area 148 as illustrated in FIG. 22.

When no candidate word is selected, the control unit 130 checks whether a display request for additional candidate words not yet displayed in the candidate group display area 147 is made in Step 750. A display request for additional candidate words may be made by dragging in the left direction on the candidate group display area 147. When a display request for additional candidate words is made, the control unit 130 returns to Step 740 and displays next candidate words in the candidate group display area 147.

When a display request for additional candidate words is not made, the control unit 130 checks whether an edit event is generated in Step 755. Here, similarly to the case of the first method, an edit event may correspond to generation of a backspace, a space, an enter or an input mode change. When an edit event is generated, the control unit 130 performs an operation indicated by the edit event in Step 757.

When an edit event is not generated, the control unit 130 checks whether a new character is input through the virtual keyboard area 441 in Step 765. When a new character is input, the control unit 130 returns to Step 725 and displays the new character in the input character display area 148. When no new character is input, the control unit 130 ends the process.

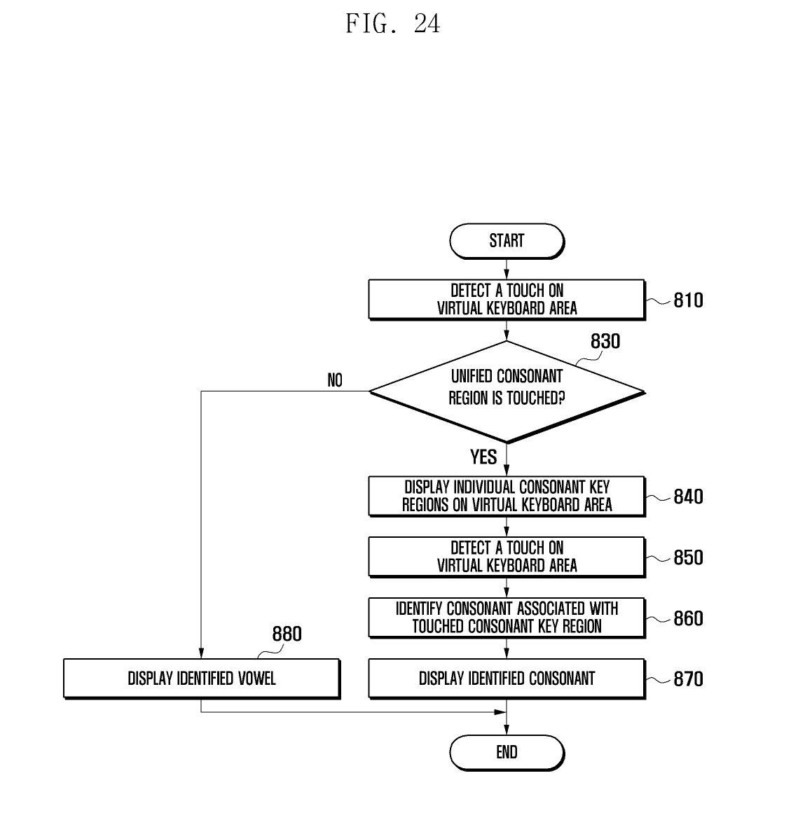

FIG. 24 is a detailed flowchart of a procedure for displaying a character in the fourth method of FIG. 23.

Referring to FIG. 24, the control unit 130 detects a touch on the virtual keyboard area 441 in Step 810. The control unit 130 examines whether the unified consonant region 442 is touched in Step 830. When the unified consonant region 442 is touched, the control unit 130 displays individual consonant key regions on the virtual keyboard area 441 as illustrated in FIG. 19 in Step 840.

After display of consonant key regions, the control unit 130 detects a touch on the virtual keyboard area 441 in Step 850. The control unit 130 identifies a consonant associated with the touched consonant key region in Step 860. The control unit 130 displays the identified consonant in the input character display area 148 in Step 870. For example, when a consonant key region 451 for the consonant ‘ [symbol] ’ is touched as illustrated in FIG. 20, the control unit 130 displays the consonant ‘ [symbol] ’ in the input character display area 148. More specifically, after display of the consonant key regions, the user may touch a desired consonant key region and drag the same to the input character display area 148 to enter a particular consonant. Alternatively, after display of the consonant key regions, the user may touch (tap) a desired consonant key region to enter a particular consonant.

When the unified consonant region 442 is not touched at Step 830, the control unit 130 displays a vowel associated with the touched vowel region 443, 444 or 445 in the input character display area 148 in Step 880. For example, when the first vowel region 443 is touched in a state of FIG. 20, the vowel ‘ [symbol] ’ associated with the first vowel region 443 is displayed in the input character display area 148 as illustrated in FIG. 21.

According to an aspect of the present invention, there is provided a virtual keyboard area composed of a basic consonant region for entering basic consonants representing all consonants, and vowel regions. When the user enters basic characters through the virtual keyboard area, candidate words corresponding to the basic characters are presented. When one of the candidate words is selected, the selected candidate word is entered and displayed. Hence, as the number of consonant and vowel key regions in the virtual keyboard area may be minimized, the user can be aware of consonant and vowel key positions with little effort. As a result, the user may enter characters through the virtual keyboard area in a more convenient way.

Although various embodiments of the present invention have been described in detail herein, many variations and modifications may be made without departing from the spirit and scope of the present invention, as defined by the appended claims.

What is claimed is:

1. A character input method using a touchscreen, comprising:
displaying a virtual keyboard area;
displaying basic characters entered through the virtual keyboard area;
displaying one or more candidate words corresponding to the entered basic characters; and
displaying, when one of the candidate words is selected, the selected candidate word.

2. The character input method of claim 1, wherein displaying the virtual keyboard area comprises displaying a virtual keyboard area having separate basic consonant and vowel regions.

3. The character input method of claim 2, wherein the virtual keyboard area includes one basic consonant region and multiple vowel regions.

4. The character input method of claim 1, wherein displaying basic characters comprises:
detecting a touch on the virtual keyboard area;
identifying a basic consonant or a vowel corresponding to the touched region; and
displaying the identified basic consonant or vowel.

5. The character input method of claim 1, wherein displaying one or more candidate words comprises:
determining whether words corresponding to currently displayed basic characters are present in a database; and
displaying, when words corresponding to currently displayed basic characters are present in the database, the corresponding words as candidate words.

6. The character input method of claim 5, wherein determining whether corresponding words are present in a database comprises searching the database for words including characters corresponding to syllables of the basic characters.

7. The character input method of claim 6, wherein searching the database for words including characters corresponding to syllables comprises examining the type of a vowel of each syllable of the basic characters and checking for presence of a final consonant in the syllable.

8. The character input method of claim 1, further comprising displaying, when a display request for additional candidate words is made, next candidate words not yet displayed.

9. The character input method of claim 8, further comprising:
checking whether an edit event is generated; and
performing, when an edit event is generated, an operation corresponding to generation of a backspace, a space, an enter or an input mode change as indicated by the edit event.

10. The character input method of claim 9, wherein performing an operation comprises performing automatic selection in response to generation of a space, an enter or an input mode change.

11. The character input method of claim 2, wherein displaying basic characters comprises:
displaying, when the basic consonant region is touched, consonant key regions associated with consonants of the basic consonant region in the virtual keyboard area; and
displaying a consonant associated with a touched consonant key region of the displayed consonant key regions.

12. The character input method of claim 2, wherein the virtual keyboard area is composed of a first basic consonant region for entering a basic consonant corresponding to an initial consonant, a second basic consonant region for entering a basic consonant corresponding to a final consonant, and multiple vowel regions.

13. The character input method of claim 2, wherein the virtual keyboard area is composed of a first basic consonant region for entering a basic consonant corresponding to a single initial consonant, a second basic consonant region for entering a basic consonant corresponding to a single final consonant, a third basic consonant region for entering a basic consonant corresponding to a double consonant, and multiple vowel regions.

14. An electronic device comprising:
a touchscreen displaying a character input screen that is composed of a virtual keyboard area to enter basic characters, an input character display area to display basic characters entered through the virtual keyboard area, and a candidate group display area to display one or more candidate words corresponding to the entered basic characters; and
a control unit controlling a process of displaying a basic character associated with one of touched basic consonant and vowel regions in the virtual keyboard area, generating and displaying candidate words on the basis of the displayed basic character, and displaying a selected one of the candidate words in the input character display area.

15. The electronic device of claim 14, wherein the control unit controls an operation to display a basic consonant or a vowel associated with the touched region in the input character display area.

16. The electronic device of claim 14, wherein the control unit searches a database for words including characters corresponding to syllables of displayed basic characters.

17. The electronic device of claim 14, wherein the control unit examines the type of a vowel of each syllable of basic characters and checks presence of a final consonant in the syllable to conduct a database search.

18. The electronic device of claim 14, wherein the virtual keyboard area includes a basic consonant region and multiple vowel regions.

19. The electronic device of claim 14, wherein the virtual keyboard area includes a first basic consonant region for entering a basic consonant corresponding to an initial consonant, a second basic consonant region for entering a basic consonant corresponding to a final consonant, and multiple vowel regions for entering vowels.

20. The electronic device of claim 14, wherein the virtual keyboard area includes a first basic consonant region for entering a basic consonant corresponding to a single initial consonant, a second basic consonant region for entering a basic consonant corresponding to a single final consonant, a third basic consonant region for entering a basic consonant corresponding to a double consonant, and multiple vowel regions for entering vowels.

21. The electronic device of claim 14, wherein the control unit controls an operation to display, when a basic consonant region is touched, consonant key regions associated with consonants of the basic consonant region, and to display a consonant associated with a touched consonant key region of the displayed consonant key regions.
